(19) United States
(12) Patent Application Publication
(10) Pub. No.: US 2010/0182160 A1
(43) Pub. Date: Jul. 22, 2010

(54) Remote control with passive RFID tag and Zigbee arrangement

(76) Inventor: Ming-Wei Lu, Taipei (TW)

Correspondence Address: SAM CHEN, 7F-1, 293, ROOSEVELT ROAD, SEC 3, TAIPEI, TW

(21) Appl. No.: 12/356,603

(22) Filed: Jan. 21, 2009

(51) Int. Cl. G08C 19/00; G06K 9/00; G06F 3/041

(52) U.S. Cl. 340/825.69; 382/124; 345/173

(57) ABSTRACT

A remote control for consumer electronic device in one embodiment includes a passive RFID tag so as to be powered by its own rechargeable battery in operation, and a Zigbee arrangement so as to be aligned with future trend with respect to wireless transmission. In another embodiment, the remote control can be alternatively powered by a solar cell,

### BACKGROUND OF THE INVENTION

1. Field of Invention

The invention relates to remote controls and more particularly to such a remote control having a passive RFID tag so as to be powered by its own rechargeable battery in operating a consumer electronic device, and a Zigbee arrangement so as to be aligned with future trend with respect to wireless transmission. Moreover, the remote control can be additionally powered by a solar cell.

2. Description of Related Art

A remote control is typically used to control a consumer electronic device, for example, a TV. Also, typically a user has to use an associated remote control to control a consumer electronic device. Moreover, a user may have to operate a number of remote controls sequentially in order to operate a consumer electronic device (e.g., home theater). This is cumbersome.

Most typical remote controls communicate to their respective devices via infrared (IR) signals and a few via radio signals. They are usually powered by small batteries. This feature is less desired since, for example, as compared with most hand held calculators which are powered by solar cell(s) nowadays.

ZigBee is the name of a specification for a suite of high level communication protocols using small, low-power digital radios based on the IEEE 802.15.4-2006 standard for wireless personal area networks (WPANs), such as wireless headphones connecting with cell phones via short-range radio. The technology is intended to be simpler and less expensive than other WPANs. ZigBee is targeted at radio-frequency (RF) applications that require a low data rate, long battery life, and secure networking.

RFID (radio-frequency identification) is an automatic identification method, relying on storing and remotely retrieving data using devices called RFID tags or transponders. The technology requires cooperation of an RFID reader and an RFID tag. An RFID tag is an object that can be applied to or incorporated into a product, animal, or person for the purpose of identification and tracking using radio waves. Some tags can be read from several meters away and beyond the line of sight of the reader. Most RFID tags contain at least two parts. One is an integrated circuit for storing and processing information, modulating and demodulating an RF signal, and other specialized functions. The second is an antenna for receiving and transmitting the signal. A type of RFID tag called passive RFID tag even does not need a battery in operation.

U.S. Pat. No. 7,116,229 discloses device and method for programming a remote control device using RFID technology. Thus, the need for improvement still exists.

### SUMMARY OF THE INVENTION

It is therefore one object of the invention to provide a remote control having a passive RFID tag so as to be powered by its own rechargeable battery in operating a consumer electronic device, and a Zigbee arrangement so as to be aligned with future trend with respect to wireless transmission.

It is another object of the invention to provide a remote control having both a passive RFID tag and a solar cell so as to be powered by its own rechargeable battery in operating a consumer electronic device, and a Zigbee arrangement so as to be aligned with future trend with respect to wireless transmission.

The above and other objects, features and advantages of the invention will become apparent from the following detailed description taken with the accompanying drawings.

### BRIEF DESCRIPTION OF THE DRAWINGS

FIG. 1 is a block diagram according to the invention;

FIG. 2 is a block diagram of the main processor in accordance with a first preferred embodiment of the invention;

FIG. 3 is a block diagram of the main processor in accordance with a second preferred embodiment of the invention; and

FIG. 4 is a block diagram of the base.

### DETAILED DESCRIPTION OF THE INVENTION

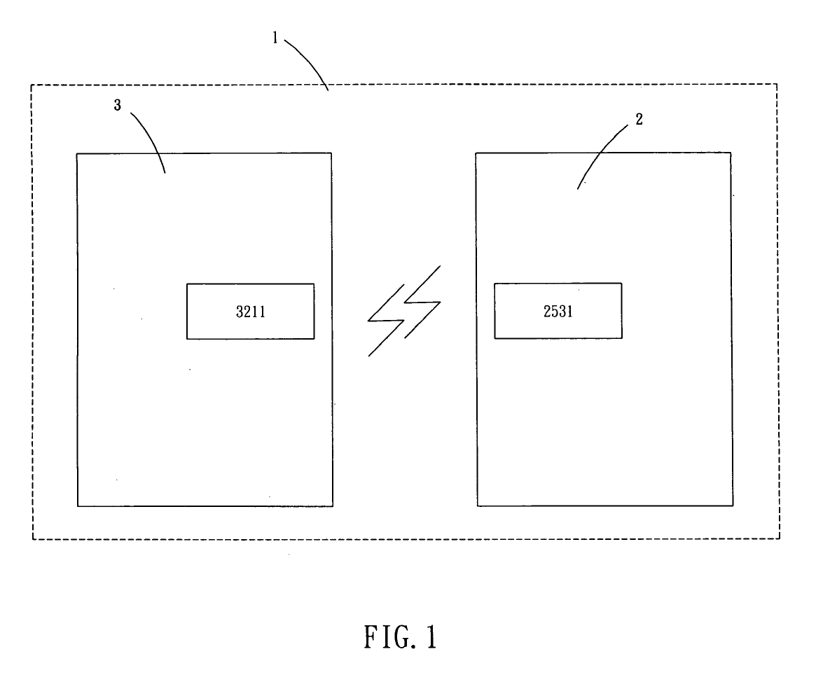

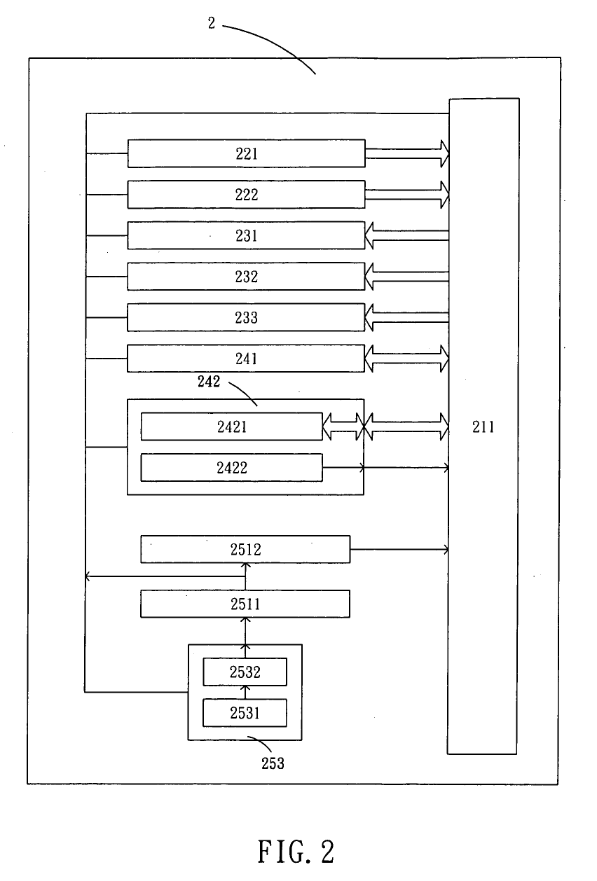

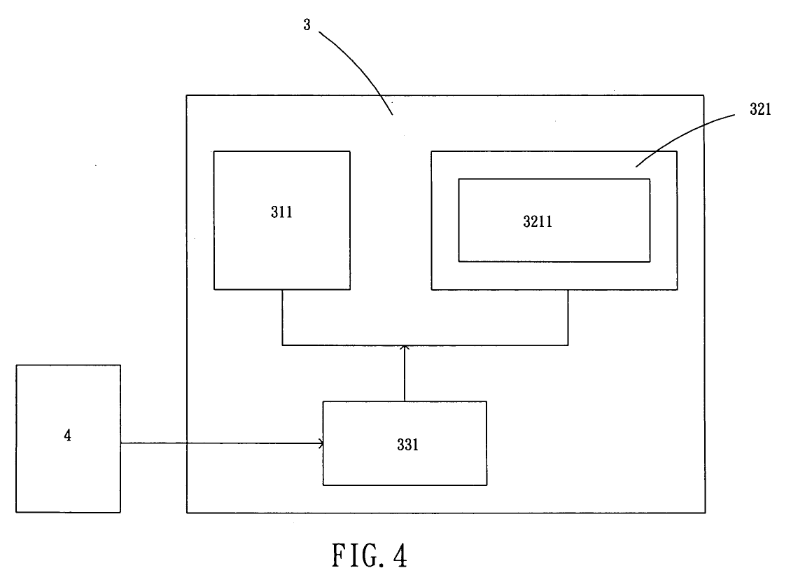

Referring to FIGS. 1, 2 and 4, a remote control 1 of the invention and a main processor 2 thereof in accordance with a first preferred embodiment of the invention are illustrated.

In addition to the main processor 2 the remote control 1 further comprises a releasable base 3 adapted to secure to the main processor 2. The main processor 2 comprises a control section, an input section, an output section, a data transmission section, and a power supply. The base 3 comprises a control section, a data transmission section, and a power supply.

The control section of the main processor 2 comprises a microcontroller 211. The input section of the main processor 2 comprises a touch screen unit 221. The output section of the main processor 2 comprises a light-emitting diode (LED) unit 231 and a voice unit 232. The data transmission section of the main processor 2 comprises an IR transmission assembly 241 and a Zigbee transmission assembly 242. The power supply of the main processor 2 comprises a battery assembly including a rechargeable battery 2511 and a current sensor (CS) 2512; and an RFID assembly 253.

The microcontroller 211, the touch screen unit 221, the LED unit 231, the voice unit 232, the IR transmission assembly 241, the Zigbee transmission assembly 242, the battery 2511, the CS 2512, and the RFID assembly 253 are electrically connected together so that not only control signals and data can be communicated among them but also electric power can be supplied from the battery 2511 to other components.

The control section of the base 3 comprises a microcontroller 311. The data transmission section of the base 3 comprises an RFID assembly 321. The power supply of the base 3 comprises a power supply 331. The RFID assembly 321 and the power supply 331 are electrically connected together so that not only control signals and data can be communicated among them but also electric power can be supplied from the power supply 331 to other components.

The RFID signal transmission unit 2531 and the RFID signal transmission unit 3211 are adapted to communicate in RF signals in a wireless manner. Also, electric power (e.g., alternating current (AC)) is generated during the communication. The electric power is then converted into direct current (DC) and is supplied to the rechargeable battery 2511 for storage. Hence, the main processor 2 may be powered by the battery 2511 in operation.

The IR transmission assembly 241 and the Zigbee transmission assembly 242 are adapted to communicate each other in the form of IR signal. This means that the main processor 2 has more than one mode of wireless communication. Hence, the remote control 1 of the invention, similar to a universal remote control, is capable of controlling a variety of consumer electronic devices. Moreover, the remote control 1 of the invention can operate by its own power similar to a solar powered calculator.

The touch screen unit 221 has a data output port which is connected to a data input port of the microcontroller 211. Hence, typed data can be sent from the data output port of the touch screen unit 221 to the data input port of the microcontroller 211. The microcontroller 211 may then control a respective consumer electronic device as instructed by the input data. The LED unit 231 is connected to data output port of the microcontroller 211 so that control data sent from the microcontroller 211 can be received by the LED unit 231. The LED unit 231 may light, dim, or flash to indicate the status of the main processor 2.

The data input port of the voice unit 232 is connected to the data output port of the microcontroller 211. Hence, voice data can be sent from the microcontroller 211 to the voice unit 232. The voice unit 232 may inform or alert user audibly as a response.

The data output port of the IR transmission assembly 241 is connected to data input port of the microcontroller 211. Hence, the microcontroller 211 may send data or control signals from the IR transmission assembly 241 to a remote device having an IR transmission assembly 241. The data input port of the IR transmission assembly 241 is connected to data output port of the microcontroller 211. Hence, the microcontroller 211 may receive data or control signals from a remote device having an IR transmission assembly 241. As stated in the background section, most typical remote controls communicate to their respective devices via IR signals. For the reason of compatibility, the main processor 2 is also provided with the IR transmission assembly 241. Hence, the remote control of the invention is still capable of controlling a corresponding consumer electronic device of such type.

The data output port of the Zigbee transmission assembly 242 of the main processor 2 is connected to the data input port of the microcontroller 211. The data input port of the Zigbee transmission assembly 242 is connected to data output port of the microcontroller 211. Hence, a bi-directional data communication between the Zigbee transmission assembly 242 and the microcontroller 211 is made possible. With the provision of the Zigbee transmission assembly 242, the main processor 2 is capable of controlling a corresponding consumer electronic device having a Zigbee arrangement.

Power output of the RFID assembly 253 of the main processor 2 is connected to power input of the battery 2511. The power output of the battery 2511 is connected to power input of the CS 2512. The signal output of the CS 2512 is connected to signal input of the microcontroller 211. Hence, the CS 2512 is aware of the amount of remaining electric power of the battery 2511 by sending inquiry signals to power input of the battery 2511. The result is then sent to the microcontroller 211. Next, the microcontroller 211 may activate either the LED unit 231 to visually alert user by flashing or lighting the LED unit 231 or activate the voice unit 232 to audibly alert the user. Therefore, the user may know the remaining electric power of the main processor 2.

The power output of the battery 2511 of the main processor 2 is connected to the microcontroller 211, the touch screen unit 221, the LED unit 231, the voice unit 232, the IR transmission assembly 241, the Zigbee transmission assembly 242, the CS 2512, and the power input of the RFID assembly 253 for supplying DC power thereto.

The power input of the power supply 331 of the base 3 is connected to a wall outlet 4 for obtaining external electric power therefrom. The power output of the power supply 331 is connected to both power input of the microcontroller 311 and power input of the RFID assembly 321 for supplying AC power thereto.

The Zigbee transmission assembly 242 of the main processor 2 further comprises a Zigbee transmission unit 2421 and a communication range detection unit 2422. The data output port of the Zigbee transmission unit 2421 is connected to data output port of the Zigbee transmission assembly 242. Hence, the microcontroller 211 is capable of receiving data or control signals sent from a remote device having the Zigbee transmission unit 2421 via the Zigbee transmission unit 2421. The data input port of the Zigbee transmission unit 2421 is connected to data input port of the Zigbee transmission assembly 242. Hence, the microcontroller 211 is capable of transmitting data or control signals to a remote device having the Zigbee transmission unit 2421 via the Zigbee transmission unit 2421. The signal output of the communication range detection unit 2422 is connected to the signal output of the Zigbee transmission unit 2421 which is in turn connected to signal input of the microcontroller 211. Hence, the communication range detection unit 2422 is capable of determining whether a remote device having the Zigbee transmission unit 2421 is within the effective communication range of the Zigbee transmission unit 2421. Further, the communication range detection unit 2422 may send control signals to the microcontroller 211. Thus, the microcontroller 211 may activate either the LED unit 231 to visually alert user by flashing or lighting the LED unit 231 or activate the voice unit 232 to audibly alert the user. Therefore, the user may know whether the main processor 2 is within the effective communication range of the Zigbee transmission assembly 242.

The RFID assembly 253 of the main processor 2 further comprises an RFID signal transmission unit 2531 and a transformer 2532. The RFID assembly 321 of the base 3 further comprises an RFID signal transmission unit 3211. The output port of the RFID signal transmission unit 2531 of the RFID assembly 253 is connected to output port of the transformer 2532. The output port of the transformer 2532 is connected to power output of the RFID assembly 253. The RFID signal transmission unit 2531 and the RFID signal transmission unit 3211 are adapted to communicate in RF signals in a wireless manner. Also, AC electric power is generated during the communication. The transformer 2532 of the RFID assembly 253 is adapted to convert AC into DC for consumption of the main processor 2 or battery storage.

The input section of the main processor 2 further comprises a finger print recognition unit 222. The output section of the main processor 2 further comprises an LCD (liquid crystal display) 233. The data output port of the finger print recognition unit 222 is connected to data input port of the microcontroller 211. Hence, a user may put his/her palm on the finger print recognition unit 222 which may then activate to scan the palm to get finger print data. The finger print data is again sent to the microcontroller 211 for comparing with a plurality of finger print records stored therein. If the comparison result is that the finger print data is the same as one of the finger print records. Then the user may use the remote control 1. This feature aims at limiting the remote control 1 or some important functions thereof to be used by only authorized person(s).

The data input port of the display 233 is connected to the data output port of the microcontroller 211. Hence, the microcontroller 211 is capable of sending alphanumeric data, pictures, etc. to the display 233 for display. Power inputs of both the finger print recognition unit 222 and the display 233 are connected to the power output of the battery 2511. Hence, the battery 2511 may supply DC power to both the finger print recognition unit 222 and the display 233 for maintaining its normal operations.

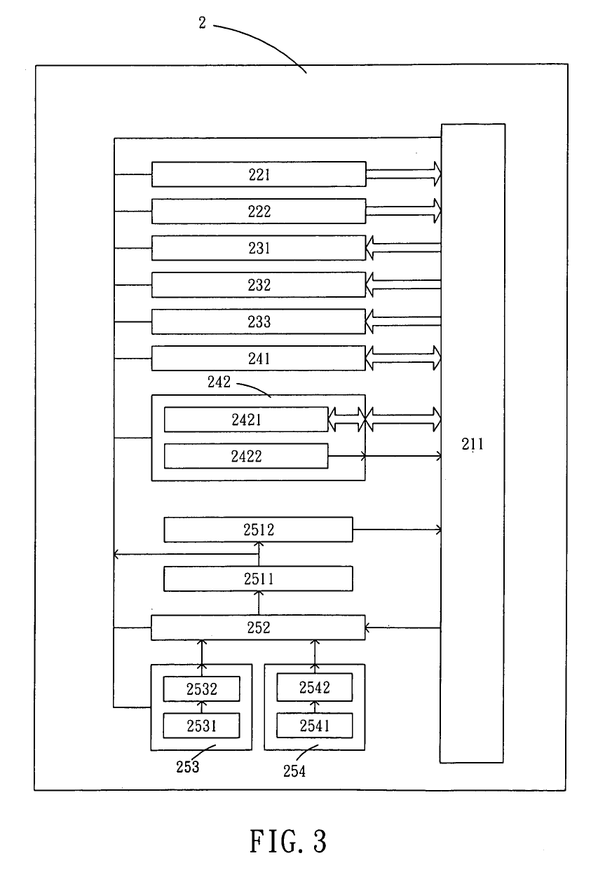

Referring to FIGS. 1, 3 and 4, a remote control 1 of the invention and a main processor 2 thereof in accordance with a second preferred embodiment of the invention are illustrated. The characteristics of the second preferred embodiment are detailed unit below.

In addition to the main processor 2 the remote control 1 further comprises a releasable base 3 adapted to secure to the main processor 2. The main processor 2 comprises a control section, an input section, an output section, a data transmission section, and a power supply. The base 3 comprises a control section, a data transmission section, and a power supply.

The control section of the main processor 2 comprises a microcontroller 211. The input section of the main processor 2 comprises a touch screen unit 221. The output section of the main processor 2 comprises a light-emitting diode (LED) unit 231 and a voice unit 232. The data transmission section of the main processor 2 comprises an IR transmission assembly 241 and a Zigbee transmission assembly 242. The power supply of the main processor 2 comprises a battery assembly including a rechargeable battery 2511 and a current sensor (CS) 2512; an RFID assembly 253; a solar power assembly 254 having a solar panel 2541 and a solar cell 2542; and a switch 252.

The microcontroller 211, the touch screen unit 221, the LED unit 231, the voice unit 232, the IR transmission assembly 241, the Zigbee transmission assembly 242, the battery 2511, the CS 2512, and the RFID assembly 253 are electrically connected together so that not only control signals and data can be communicated among them but also electric power can be supplied from the battery 2511 to other components.

The control section of the base 3 comprises a microcontroller 311. The data transmission section of the base 3 comprises an RFID assembly 321. The power supply of the base 3 comprises a power supply 331. The RFID assembly 321 and the power supply 331 are electrically connected together so that not only control signals and data can be communicated among them but also electric power can be supplied from the power supply 331 to other components.

The RFID signal transmission unit 2531 and the RFID signal transmission unit 3211 are adapted to communicate in RF signals in a wireless manner. Also, electric power (alternating current (AC)) is generated during the communication. The electric power is then converted into (direct current) DC and is supplied to the rechargeable battery 2511 for storage. Hence, the main processor 2 may be powered by the battery 2511 in operation.

The IR transmission assembly 241 and the Zigbee transmission assembly 242 are adapted to communicate each other in the form of IR signal. This means that the main processor 2 has more than one mode of wireless communication. Hence, the remote control 1 of the invention, similar to a universal remote control, is capable of controlling a variety of consumer electronic devices. Moreover, the remote control 1 of the invention can operate by its own power similar to a solar powered calculator.

The touch screen unit 221 has a data output port which is connected to a data input port of the microcontroller 211. Hence, typed data can be sent from the data output port of the touch screen unit 221 to the data input port of the microcontroller 211. The microcontroller 211 may then control a respective consumer electronic device as instructed by the input data. The LED unit 231 is connected to data output port of the microcontroller 211 so that control data sent from the microcontroller 211 can be received by the LED unit 231. The LED unit 231 may light, dim, or flash to indicate the status of the main processor 2.

The data input port of the voice unit 232 is connected to the data output port of the microcontroller 211. Hence, voice data can be sent from the microcontroller 211 to the voice unit 232. The voice unit 232 may inform or alert user audibly as a response.

The data output port of the IR transmission assembly 241 is connected to data input port of the microcontroller 211. Hence, the microcontroller 211 may send data or control signals from the IR transmission assembly 241 to a remote device having an IR transmission assembly 241. The data input port of the IR transmission assembly 241 is connected to data output port of the microcontroller 211. Hence, the microcontroller 211 may receive data or control signals from a remote device having an IR transmission assembly 241. As stated in the background section, most typical remote controls communicate to their respective devices via IR signals. For the reason of compatibility, the main processor 2 is also provided with the IR transmission assembly 241. Hence, the remote control of the invention is still capable of controlling a corresponding consumer electronic device of such type.

The data output port of the Zigbee transmission assembly 242 of the main processor 2 is connected to the data input port of the microcontroller 211. The data input port of the Zigbee transmission assembly 242 is connected to data output port of the microcontroller 211. Hence, a bi-directional data communication between the Zigbee transmission assembly 242 and the microcontroller 211 is made possible. With the provision of the Zigbee transmission assembly 242, the main processor 2 is capable of controlling a corresponding consumer electronic device having a Zigbee arrangement.

Power output of the RFID assembly 253 of the main processor 2 is connected to power input of the battery 2511. The power output of the battery 2511 is connected to power input of the CS 2512. The signal output of the CS 2512 is connected to signal input of the microcontroller 211. Hence, the CS 2512 is aware of the amount of remaining electric power of the battery 2511 by sending inquiry signals to power input of the battery 2511. The result is then sent to the microcontroller 211. Next, the microcontroller 211 may activate either the LED unit 231 to visually alert user by flashing or lighting the LED unit 231 or activate the voice unit 232 to audibly alert the user. Therefore, the user may know the remaining electric power of the main processor 2.

The power output of the battery 2511 of the main processor 2 is connected to the microcontroller 211, the touch screen unit 221, the LED unit 231, the voice unit 232, the IR transmission assembly 241, the Zigbee transmission assembly 242, the CS 2512, and the power input of the RFID assembly 253 for supplying DC power thereto.

The power input of the power supply 331 of the base 3 is connected to a wall outlet 4 for obtaining external electric power therefrom. The power output of the power supply 331 is connected to both power input of the microcontroller 311 and power input of the RFID assembly 321 for supplying AC power thereto.

The Zigbee transmission assembly 242 of the main processor 2 further comprises a Zigbee transmission unit 2421 and a communication range detection unit 2422. The data output port of the Zigbee transmission unit 2421 is connected to data output port of the Zigbee transmission assembly 242. Hence, the microcontroller 211 is capable of receiving data or control signals sent from a remote device having the Zigbee transmission unit 2421 via the Zigbee transmission unit 2421. The data input port of the Zigbee transmission unit 2421 is connected to data input port of the Zigbee transmission assembly 242. Hence, the microcontroller 211 is capable of transmitting data or control signals to a remote device having the Zigbee transmission unit 2421 via the Zigbee transmission unit 2421. The signal output of the communication range detection unit 2422 is connected to the signal output of the Zigbee transmission unit 2421 which is in turn connected to signal input of the microcontroller 211. Hence, the communication range detection unit 2422 is capable of determining whether a remote device having the Zigbee transmission unit 2421 is within the effective communication range of the Zigbee transmission unit 2421. Further, the communication range detection unit 2422 may send control signals to the microcontroller 211. Thus, the microcontroller 211 may activate either the LED unit 231 to visually alert user by flashing or lighting the LED unit 231 or activate the voice unit 232 to audibly alert the user. Therefore, the user may know whether the main processor 2 is within the effective communication range of the Zigbee transmission assembly 242.

The RFID assembly 253 of the main processor 2 further comprises an RFID signal transmission unit 2531 and a transformer 2532. The RFID assembly 321 of the base 3 further comprises an RFID signal transmission unit 3211. The output port of the RFID signal transmission unit 2531 of the RFID assembly 253 is connected to output port of the transformer 2532. The output port of the transformer 2532 is connected to power output of the RFID assembly 253. The RFID signal transmission unit 2531 and the RFID signal transmission unit 3211 are adapted to communicate in RF signals in a wireless manner. Also, AC electric power is generated during the communication. The transformer 2532 of the RFID assembly 253 is adapted to convert AC into DC for consumption of the main processor 2 or battery storage.

The input section of the main processor 2 further comprises a finger print recognition unit 222. The output section of the main processor 2 further comprises an LCD (liquid crystal display) 233. The data output port of the finger print recognition unit 222 is connected to data input port of the microcontroller 211. Hence, a user may put his/her palm on the finger print recognition unit 222 which may then activate to scan the palm to get finger print data. The finger print data is again sent to the microcontroller 211 for comparing with a plurality of finger print records stored therein. If the comparison result is that the finger print data is the same as one of the finger print records. Then the user may use the remote control 1. This feature aims at limiting the remote control 1 or some important functions thereof to be used by only authorized person(s).

The data input port of the display 233 is connected to the data output port of the microcontroller 211. Hence, the microcontroller 211 is capable of sending alphanumeric data, pictures, etc. to the display 233 for display. Power inputs of both the finger print recognition unit 222 and the display 233 are connected to the power output of the battery 2511. Hence, the battery 2511 may supply DC power to both the finger print recognition unit 222 and the display 233 for maintaining its normal operations.

The solar panel 2541 may convert solar energy from the sun or the lamp into DC power which is in turn stored in the solar cell 2542. The switch 252 is controlled by the microcontroller 211. Each of the RFID assembly 253 and the solar power assembly 254 is connected to the switch 252 which is in turn connected to the battery 2511. The battery 2511 of the main processor 2 may be low if the main processor 2 is detached from the base 3 for a prolonged period of time. For avoiding this, a user may slide the switch 252 to cause the microcontroller 211 to interconnect the solar power assembly 254 and the battery 2511. Immediately, the battery 2511 is charged by the solar cell 2542. This feature makes the invention to be one powered by an uninterruptible power supply.

While the invention herein disclosed has been described by means of specific embodiments, numerous modifications and variations could be made thereto by those skilled in the art without departing from the scope and spirit of the invention set forth in the claims.

What is claimed is:

1. A remote control comprising:
a main processor (2) comprising a microcontroller (211), a touch screen unit (221), a light-emitting diode (LED) unit (231), a voice unit (232), a display (233), an IR transmission assembly (241), a Zigbee transmission assembly (242) including a Zigbee transmission unit (2421) and a communication range detection unit (2422), a CD (current sensor) (2512), a radio-frequency identification (RFID) assembly (253) including an RFID signal transmission unit (2531) and a transformer (2532), and a rechargeable battery (2511) for supplying DC power to each of the microcontroller (211), the touch screen unit (221), the LED unit (231), the voice unit (232), the display (233), the IR transmission assembly (241), the Zigbee transmission assembly (242), the CS (2512), and the RFID assembly (253); and
a releasable base (3) comprising a microcontroller (311), an RFID assembly (321) including an RFID signal transmission unit (3211), and a power supply (331), wherein
the RFID signal transmission unit (2531) and the RFID signal transmission unit (3211) are adapted to communicate in radio-frequency (RF) signals wirelessly with AC (alternating current) power being generated during the communication, the transformer (2532) is adapted to convert the AC power into DC (direct current) power, and the DC power is supplied to the battery (2511) for storage;
the IR transmission assembly (241) and the Zigbee transmission assembly (242) are adapted to communicate in infrared (IR) signals, the touch screen unit (221) has a data output port connected to a data input port of the microcontroller (211), the LED unit (231) is connected to a data output port of the microcontroller (211), and the LED unit (231) is adapted to light, dim, or flash to indicate the status of the main processor (2);
a data input port of the voice unit (232) is connected to the data output port of the microcontroller (211) and the voice unit (232) is adapted to alert a user audibly;
a data output port of the IR transmission assembly (241) is connected to a data input port of the microcontroller (211) such that the microcontroller (211) is adapted to send data or control signals from the IR transmission assembly (241) to a remote device having an IR transmission assembly (241);
the data input port of the IR transmission assembly (241) is connected to a data output port of the microcontroller (211) such that the microcontroller (211) is adapted to receive data or control signals from the remote device having an IR transmission assembly (241);
a data output port of the Zigbee transmission assembly (242) is connected to the data input port of the microcontroller (211) and a data input port thereof is connected to the data output port of the microcontroller (211);
a power input of the battery (2511) is connected to a power output of the RFID assembly (253) and a power output thereof is connected to a power input of the CS (2512), and a signal output of the CS (2512) is connected to a signal input of the microcontroller (211);
the power output of the battery (2511) is connected to each of the microcontroller (211), the touch screen unit (221), the LED unit (231), the voice unit (232), the IR transmission assembly (241), the Zigbee transmission assembly (242), the CS (2512), and a power input of the RFID assembly (253) for supplying DC power thereto;
a power input of the power supply (331) is connected to an external power source (4) for obtaining AC power therefrom and a power output thereof is connected to both a power input of the microcontroller (311) and a power input of the RFID assembly (321) for supplying AC power thereto;
a data output port of the Zigbee transmission unit (2421) is connected to the data output port of the Zigbee transmission assembly (242) such that the microcontroller (211) is adapted to receive data or control signals sent from the remote device having a Zigbee transmission unit (2421) via the Zigbee transmission unit (2421);
a data input port of the Zigbee transmission unit (2421) is connected to a data input port of the Zigbee transmission assembly (242) such that the microcontroller (211) is adapted to transmit data or control signals to the remote device having a Zigbee transmission unit (2421) via the Zigbee transmission unit (2421);
a signal output of the communication range detection unit (2422) is connected to a signal output of the Zigbee transmission unit (2421) which is connected to the signal input of the microcontroller (211) such that the communication range detection unit (2422) is adapted to determine whether the remote device having a Zigbee transmission unit (2421) is within an effective communication range of the Zigbee transmission unit (2421), and the communication range detection unit (2422) is adapted to send control signals to the microcontroller (211) for activating either the LED unit (231) or the voice unit (232);
an output port of the RFID signal transmission unit (2531) is connected to an output port of the transformer (2532) which is connected to the power output of the RFID assembly (253); and
a data input port of the display (233) is connected to the data output port of the microcontroller (211) such that the display (233) is adapted to display input data from the microcontroller (211).

2. The remote control of claim 1, wherein the main processor (2) further comprises a finger print recognition unit (222) including a data output port connected to the data input port of the microcontroller (211).

3. A remote control comprising:
a main processor (2) comprising a microcontroller (211), a touch screen unit (221), a light-emitting diode (LED) unit (231), a voice unit (232), a display (233), an IR transmission assembly (241), a Zigbee transmission assembly (242) including a Zigbee transmission unit (2421) and a communication range detection unit (2422), a CD (current sensor) (2512), a radio-frequency identification (RFID) assembly (253) including an RFID signal transmission unit (2531) and a transformer (2532), a solar power assembly (254) including a solar panel (2541) and a solar cell (2542), a switch (252), and a rechargeable battery (2511) for supplying DC power to each of the microcontroller (211), the touch screen unit (221), the LED unit (231), the voice unit (232), the display (233), the IR transmission assembly (241), the Zigbee transmission assembly (242), the CS (2512), the switch (252), and the RFID assembly (253); and
a releasable base (3) comprising a microcontroller (311), an RFID assembly (321) including an RFID signal transmission unit (3211), and a power supply (331), wherein
the RFID signal transmission unit (2531) and the RFID signal transmission unit (3211) are adapted to communicate in radio-frequency (RF) signals wirelessly with AC (alternating current) power being generated during the communication, the transformer (2532) is adapted to convert the AC power into DC (direct current) power, and the DC power is supplied to the battery (2511) for storage;
the IR transmission assembly (241) and the Zigbee transmission assembly (242) are adapted to communicate in infrared (IR) signals, the touch screen unit (221) has a data output port connected to a data input port of the microcontroller (211), the LED unit (231) is connected to a data output port of the microcontroller (211), and the LED unit (231) is adapted to light, dim, or flash to indicate the status of the main processor (2);
a data input port of the voice unit (232) is connected to the data output port of the microcontroller (211) and the voice unit (232) is adapted to alert a user audibly;
a data output port of the IR transmission assembly (241) is connected to a data input port of the microcontroller (211) such that the microcontroller (211) is adapted to send data or control signals from the IR transmission assembly (241) to a remote device having an IR transmission assembly (241);
the data input port of the IR transmission assembly (241) is connected to a data output port of the microcontroller (211) such that the microcontroller (211) is adapted to receive data or control signals from the remote device having an IR transmission assembly (241);
a data output port of the Zigbee transmission assembly (242) is connected to the data input port of the microcontroller (211) and a data input port thereof is connected to the data output port of the microcontroller (211);
a power input of the battery (2511) is connected to a power output of the RFID assembly (253) and a power output thereof is connected to a power input of the CS (2512), and a signal output of the CS (2512) is connected to a signal input of the microcontroller (211);
the power output of the battery (2511) is connected to each of the microcontroller (211), the touch screen unit (221), the LED unit (231), the voice unit (232), the IR transmission assembly (241), the Zigbee transmission assembly (242), the CS (2512), and a power input of the RFID assembly (253) for supplying DC power thereto;
a power input of the power supply (331) is connected to an external power source (4) for obtaining AC power therefrom and a power output thereof is connected to both a power input of the microcontroller (311) and a power input of the RFID assembly (321) for supplying AC power thereto;
a data output port of the Zigbee transmission unit (2421) is connected to the data output port of the Zigbee transmission assembly (242) such that the microcontroller (211) is adapted to receive data or control signals sent from the remote device having a Zigbee transmission unit (2421) via the Zigbee transmission unit (2421);
a data input port of the Zigbee transmission unit (2421) is connected to a data input port of the Zigbee transmission assembly (242) such that the microcontroller (211) is adapted to transmit data or control signals to the remote device having a Zigbee transmission unit (2421) via the Zigbee transmission unit (2421);
a signal output of the communication range detection unit (2422) is connected to a signal output of the Zigbee transmission unit (2421) which is connected to the signal input of the microcontroller (211) such that the communication range detection unit (2422) is adapted to determine whether the remote device having a Zigbee transmission unit (2421) is within an effective communication range of the Zigbee transmission unit (2421), and the communication range detection unit (2422) is adapted to send control signals to the microcontroller (211) for activating either the LED unit (231) or the voice unit (232);
an output port of the RFID signal transmission unit (2531) is connected to an output port of the transformer (2532) which is connected to the power output of the RFID assembly (253);
a data input port of the display (233) is connected to the data output port of the microcontroller (211) such that the display (233) is adapted to display input data from the microcontroller (211);
the solar panel (2541) is adapted to convert solar energy from the sun or a light source into DC power which is stored in the solar cell (2542);
each of the RFID assembly (253) and the solar power assembly (254) is connected to the switch (252); and
the switch (252) is adapted to dispose either in a first position to interconnect the RFID assembly (253) and the battery (2511) or in a second position to interconnect the solar power assembly (254) and the battery (2511).

4. The remote control of claim 3, wherein the main processor (2) further comprises a finger print recognition unit (222) including a data output port connected to the data input port of the microcontroller (211).
